(19) United States
(12) Patent Application Publication
(10) Pub. No.: US 2004/0135038 A1
(43) Pub. Date: Jul. 15, 2004

(54) Mounting assemblies

(76) Inventors: Peter Clarence Barton, West Midlands (GB); Stephan Paul Barton, West Midlands (GB)

Correspondence Address: SMITH-HILL AND BEDELL, 12670 N W BARNES ROAD, SUITE 104, PORTLAND, OR, 97229

(21) Appl. No.: 10/475,542

(22) PCT Filed: Apr. 22, 2002
(86) PCT No.: PCT/GB02/01817

(30) Foreign Application Priority Data
Apr. 20, 2001 (GB) 0109713.8

(51) Int. Cl. F16L 3/00

(52) U.S. Cl. 248/59; 248/317

(57) ABSTRACT

A mounting assembly (10) includes an elongate member (12) in the form of a loop to support articles such as pipes. The loop extends around the pipe and into a bracket (24) which forms a tiltable joint through end (16) of the loop (14) held in slots (34) of the bracket (24). The bracket can be secured on a threaded drop rod (44) in order to adjust the position of the elongate member and bracket (26) as required for installation of the pipe.

The present invention concerns mounting assemblies, and particularly but not exclusively such assemblies for mounting objects such as conduits to a fixture.

Often conduits such as piping, cables and the like are attached to fixtures such as walls, ceilings and other fixed members to be held from presenting an obstruction and to mitigate problems of damage to the conduit. In industrial environments, such as factories and the like, conduits such as power, heating, plumbing and lighting are often routed up to and across the ceiling or roof, attached by clips to ceiling or roofing members where they are relatively safe from accidental damage and present no obstruction or hazard to any workers or equipment therebelow. Further, sprinkler and other fire safety systems usually comprise pipework which is suspended by attachment from the ceiling or supporting structure of a factory or building.

A known design of clip used to effect such attachment comprises a looped strap of metal in each end of which is formed a hole. The holes are passed over a threaded bar attached to the fixture, and cooperable nuts on either side of the strip are moved together to clamp the ends of the strap therebetween whereby to define a closed loop around the conduit.

With these known designs of clip, the strap must be located around the conduits to be fixed thereby, and then lifted until the holes align, the threaded bar located through the holes and then the second locking nut located on the threaded bar and tightened, all whilst the conduits are held in the loop, usually at an elevated height within the factory. It will be appreciated therefore that such known designs of clip suffer from several disadvantages. Holding the length(s) of conduit(s) whilst manually manipulating a nut to engage it on the end of a threaded bar is difficult, time consuming and dangerous, particularly at elevated heights. There is also a tendency for a worker to drop the nut and such operations usually require two persons to assist each other.

The invention provides a mounting assembly, the assembly comprising an elongate member, and a mounting bracket for holding the two ends of the elongate member such that said member defines a loop in which articles can be supported, a support member being provided extending from the mounting bracket to permit mounting of the assembly to a fixture, the support member comprising a head spaced from the elongate member, which head is movably trapped within a body such that the support member is supported by the body and extends therefrom, but the alignment therebetween can be varied.

The body and support member head may have cooperable surfaces, which surfaces may be curved and may be part spherical.

The body may comprise a plug locatable within the body once the support member head has been located therein, to retain said head in the body.

The mounting bracket may comprise a first member in which the ends of the elongate member are locatable, and a second member locatable into the first member to hold the said ends therein.

The ends of the elongate member may be bent relative to the remainder of said member. The immediate ends of the elongate member may be turned through a substantial right angle such that the second member of the mounting bracket is engageable with the immediate ends to retain same in the first member.

Extending from the immediate ends the resilient elongate may comprise a first section engageable generally against inner walls of the first member. The elongate member may also comprise a second section engageable across an upper part of the first member. Said second sections may be engageable in a formation or formations in said upper part so as to prevent relative rotation to the first member.

The first member may comprise a cavity in which the ends of the elongate member are locatable and in which a part of the second member is locatable. A threaded passage may extend from said cavity. The threaded passage is preferably co-axial with said cavity and of a smaller diameter.

The second member may comprise a body part locatable in the cavity of the first member and engageable against the ends of the elongate member. The second member may also comprise a head part of greater diameter than the body part, and locatable against said upper part of the first member. A threaded passage, desirably of the same diameter as that extending through the first member, preferably extends through the head and body parts of the second member.

The support member may further comprise an elongate threaded member which, in use, extends through the threaded passages to hold the first and second members together.

The elongate member may be resilient such that it has to be strained to locate the ends thereof in the mounting bracket, and in a relaxed condition the ends of the resilient elongate member are preferably spaced further apart than when located in the mounting bracket.

The support member and/or mounting bracket may be as set out in accordance with the second aspect of the invention.

The present invention also provides a mounting assembly, the assembly comprising an elongate member, and a mounting bracket for holding the two ends of the resilient elongate member such that said member defines a loop in which articles can be supported, the mounting bracket comprising a first member in which the ends of the elongate member are locatable and a second member extendible into the first member to hold said ends therein.

The first and/or second member may be threaded and engageable with an elongate threaded support member to retain said first and second members together.

The support member may permit mounting of the assembly to a fixture.

The support member may comprise a head spaced from the elongate member, which head is movably trapped within a body such that the support member is supported by the body and extends therefrom, but the respective alignment therebetween can be varied.

Possibly, the head may enter the body through a keyhole entry and is trapped in the body in a well within that body. Typically, the head is trapped by displacement of the elongate threaded member above the well to a position which prevents removal of the head from the well. Normally, the head will be an hexagonal nut head of a bolt holding the assembly together.

Embodiments of the present Invention will now be described by way of example only and with reference to the accompanying drawings, in which:—

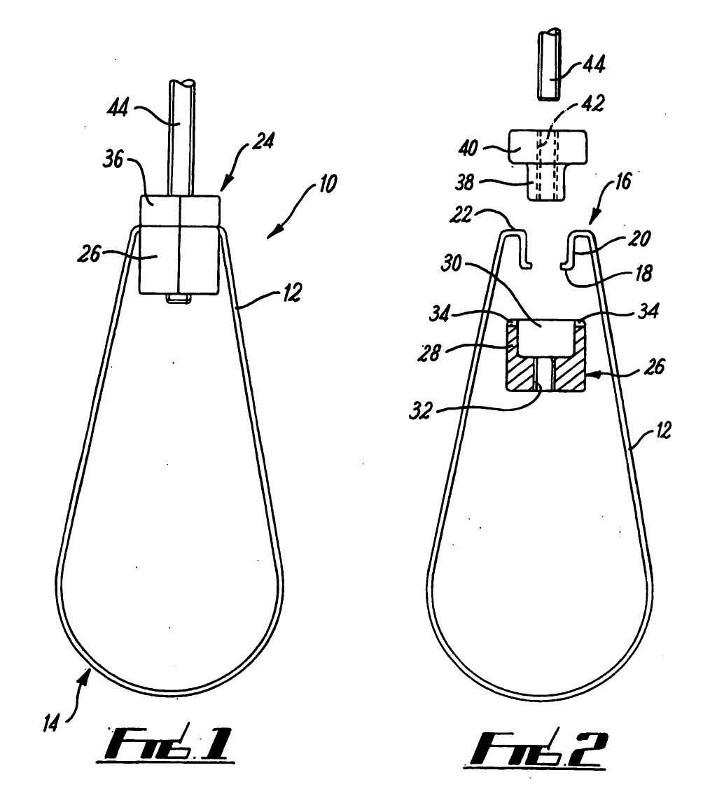

FIG. 1 is a diagrammatic view of a first mounting assembly according to the invention;

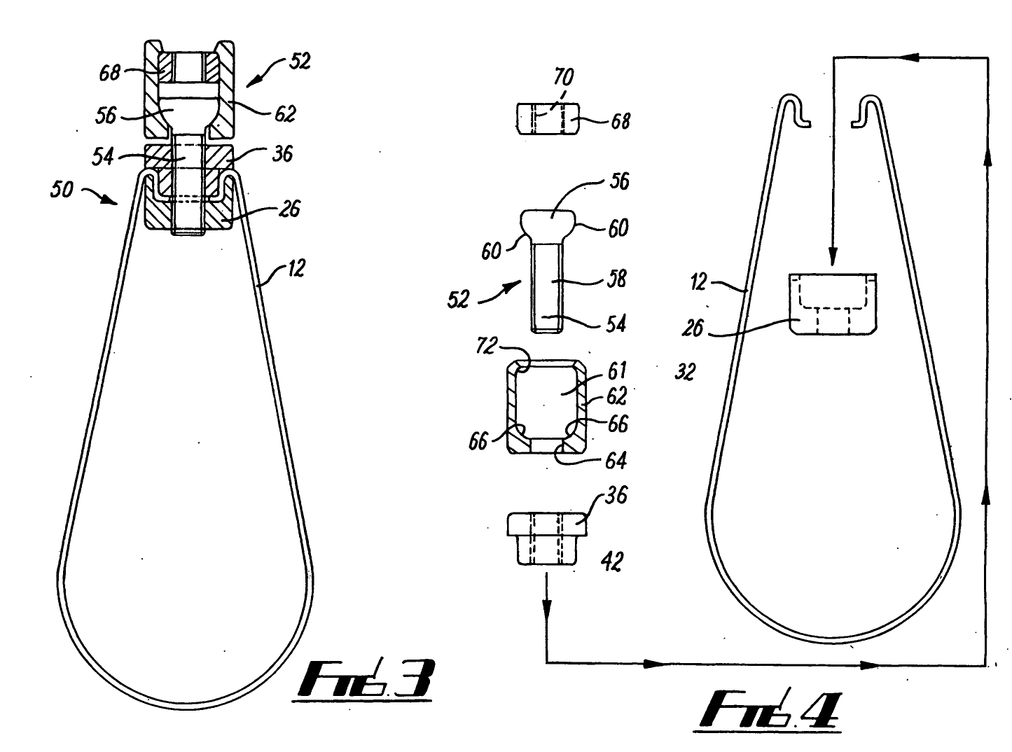

FIG. 2 is an exploded view of the assembly of FIG. 1;

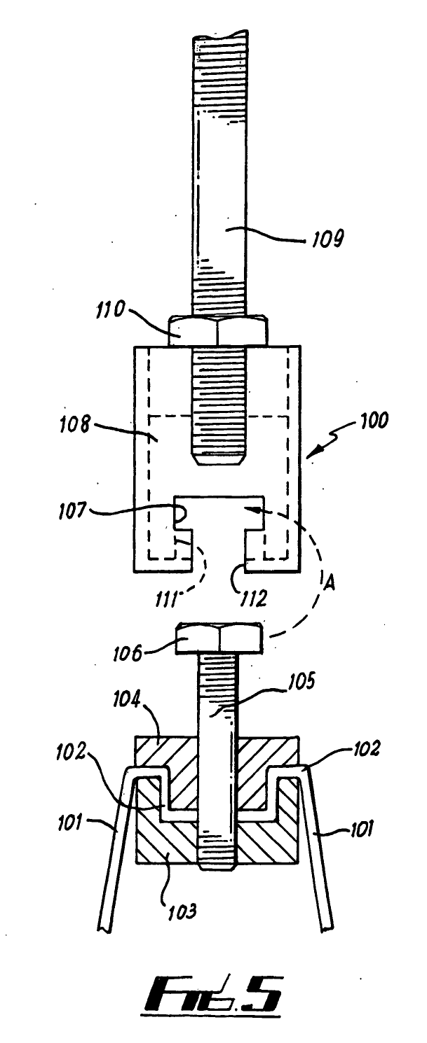

FIGS. 3 and 4 are similar views to FIGS. 1 and 2 respectively of a second mounting assembly according to the invention; and

FIG. 5 is a part schematic view of an alternative mounting assembly.

FIGS. 1 and 2 show a mounting assembly 10 suitable for mounting conduits such as piping, or cables and the like to a wall, ceiling or other fixture. The assembly 10 comprises an elongate member 12 which in use forms a loop 14 through which the conduits can extend and be supported by. The member 12 is shaped as shown in FIG. 2.

The member 12 extends in a loop from two identical ends 16. The ends 16 comprise an inwardly turned end part 18 from which a first section 20 extends substantially at a right angle (vertically in the drawings). A second section 22 is perpendicular to the first section 20, extending away from the end part 18. The remainder of the loop 14 extends in a generally horseshoe type shape.

In use the ends 16 of the loop 14 are locatable in a mounting bracket 24. The bracket 24 comprises a first part 26 with a body 28 defining a cylindrical cavity 30 for approximately half of the depth of the body 28. A concentric smaller diameter threaded passage 32 extends from the cavity 30 to the remainder of the body 28. A pair of diametrically opposed aligned slots 34 are provided in the top surface of the first part 26 either side of the cavity 30.

The bracket 24 also comprises a second part 36. The part 36 comprises a body part 38 which is locatable in the cavity 30, and a head part 40 of greater diameter which is locatable against the upper surface of the second part 36. A threaded passage 42 extends through the body and head parts 38, 40, and is of a similar size and thread to the passage 32.

FIGS. 1 and 2 illustrate a threaded drop rod 44 of the type commonly installed in buildings for use in supporting conduits etc. The rod 44 is threadedly engageable in the passages 32, 42. To put together the assembly 10, the resilient elongate member 12 is strained if necessary, and the ends 16 are located in the cavity 30. The body part 38 of the second part 36 is inserted into the cavity 30 to retain the ends 16 therein. The rod 44 is then screwed into the passages 32, 42 to mount the assembly 10 and also to retain the first and second parts 26, 36 together, clamping the ends 16 therebetween. The bottom surface of the body part 38 engages against the end parts 18 and also the member 12. Engagement of the second sections 22 in the slots 34 prevents the first part 26 rotating relative to the loop 14.

There is thus described a mounting assembly with an advantageous configuration which can readily be assembled and positioned as required.

FIGS. 3 and 4 show a further mounting assembly 50 which is similar in many respects to the assembly 10 and only the differences will be described in detail. The same reference numerals will be used for the same or similar parts. The elongate member 12 and the first and second parts 26, 36 of the mounting bracket 24 are essentially similar. However, rather than mounting directly onto a drop rod as described above, a further mounting arrangement 52 is provided which permits adjustment of the alignment of the loop 14.

The arrangement 52 comprises a threaded pin 54 engageable in the passages 32, 34 in a similar manner to the drop rod described above. The pin 54 has an enlarged head 56 with curved surfaces 60 extending from the underside of head 56 to the shaft 58 of the pin 54. The pin head 56 is restrainably located in a cavity 61 within a body 62.

The body 62 has a generally cylindrical configuration and has a lower smaller diameter opening 64 through which the shaft 58 of the pin 54 is extendible, to place the head 56 in the cavity 63. The cavity 63 widens from the opening 64, and is defined on the inside of the body by curved surfaces 66 which are cooperable with the curved surfaces 60 on the pin head 56. Both curved surfaces are preferably part-spherical. The head 56 and surfaces 66 thus form a ball-and-socket joint A plug 68 with a threaded passage 70 extending therethrough closes the cavity 63 from above and is retained therein by the tuned over upper edge 72 of the body 62. The plug 68 is located in the body after locating the pin head 56 therein during fabrication.

In use, the passage 70 is threaded onto a drop rod to support the mounting arrangement 52 and thereby support the loop member 12.

The assembly 50 provides additional advantages in comparison with the assembly 10, as follows. The assembly 50 may be pre-assembled to the condition illustrated in FIG. 3. This ensures correct assembly is achieved, which may be difficult to achieve on site. Attachment to a drop rod is a simple matter of threading the arrangement 52 onto the rod, so that this operation is quicker, and thus more economic. In addition, the ball-and-socket co-operation between the pin 54 and cavity 51 allow the fitter to accommodate misalignment of the drop rod without difficult, thus further improving the speed of fitting.

FIG. 5 illustrates an alternative mounting assembly 100 in accordance with the present invention. The assembly 100 comprises an elongate member 101 which is again formed and trapped as a loop with its ends 102 secured between respective mounting parts 103,104 held together through a screw thread 105 of a bolt with an hexagonal head 106.

The head 106 is manipulated in the direction of arrowhead A such that it enters a keyhole entry 107 in a body 108 suspended upon an elongate suspension member 109 such as a drop rod. The elongate member 109 penetrates and is displaceable upon the screw thread into the body 108 with a locking nut 110 securing the elongate member 109 at a desired position. Once the head 106 has entered the body 108 through the entry 107 the head is allowed to fall into a well 111 centrally within the body 108. The head 106 is then trapped in the body 108 by displacement of the elongate member 109 downwardly and above the well 111 such that the head 106 cannot lift up and so pass out through the entry 107. Typically, the head 106 will be allowed to move within the well 111 such that there is adjustment thereabout and in order therefore to allow for slight misalignment in the elongate member 101 which supports piping or cables etc.

By allowing the head 106 to be assembled into the assembly 100 as described with regard to FIG. 5, it will be appreciated that the elongate 101 in its loop configuration with parts 103, 104 along with the bolt incorporating the head 106 can be secured about piping or cables and, then the head manipulated as described previously through the entry 107 into the well 111 and the elongate member 109 displaced downwardly and above the well 111 to prevent removal of the head 106. In such circumstances, formation of the assembly 100 is rendered relatively easy and more convenient. Typically, the elongate members 109 in the form of drop rods along with associated body 108 can be secured at spaced positions in a ceiling or roof. The elongate member 101 along with parts 103, 104 and the bolt incorporating the head 106 can then be secured about the piping or cabling at ground level. With the respective halves of the assembly 100 thereby prepared, the piping or cabling can then be lifted to the desired approximate position and the head 106 in each assembly 100 secured as described.

Normally the head 106 will be hexagonal for convenience in locating the screw thread 105 to secure the parts 103, 104 together in formation of the loop from elongate member 101. Normally, the well 111 in the body 108 will be round with a bottom aperture 112 substantially the same as the approximate diameter of the thread 105 such that the head is captured between that aperture 112 and the appropriately located elongate member 109 such that the head 106 is at least initially loosely trapped to allow adjustment for misalignment of supported piping or cabling. However, eventually the elongate member 109 can be further displaced into direct engagement and contact with the head 106 to essentially lock the assembly 100 into a fixed configuration.

Various modifications may be made without departing from the scope of the invention. For instance the elongate member may take a different form.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A mounting assembly comprising an elongate member, and a mounting bracket for holding the two ends of the elongate member such that said member defines a loop with which articles can be supported, a support member being provided extending from the mounting bracket to permit mounting of the assembly to a fixture, the support member comprising a head spaced from the elongate member, which head is movably trapped within a body such that the support member is supported by the body and extends therefrom, but the alignment therebetween can be varied.

2. A mounting assembly according to claim 1, in which the body and support member head have cooperable surfaces.

3. A mounting assembly according to claim 2, in which the surfaces are curved.

4. A mounting assembly according to claim 3, in which the surfaces are part spherical.

5. A mounting assembly according to any preceding claim, in which the body comprises a plug locatable within the body once the support member head has been located therein, to retain the head in the body.

6. A mounting assembly according to any preceding claim, in which the mounting bracket comprises a first member in which the ends of the elongate member are locatable, and a second member locatable into the first member to hold the ends therein.

7. A mounting assembly according to claim 6, in which the ends of the elongate member are bent relative to the remainder of the member.

8. A mounting assembly according to claim 7, in which the immediate ends of the elongate member are turned through a substantial right-angle such that the second member of the mounting bracket is engageable with the immediate ends to retain the immediate ends in the first member.

9. A mounting assembly according to claim 8, in which the elongate member comprises a first section extending from the immediate ends and engageable generally against inner walls of the first member.

10. A mounting assembly according to claim 9, in which the elongate member comprises a second section engageable across an upper part of the first member.

11. A mounting assembly according to claim 10, in which the or each second section is engageable in a formation or formations in said upper part so as to prevent rotation relative to the first member.

12. A mounting assembly according to any of claims 6 to 11, in which the first member comprises a cavity in which the ends of the elongate member are locatable and in which a part of the second member is locatable.

13. A mounting assembly according to claim 12, in which a threaded passage extends from said cavity.

14. A mounting assembly according to claim 13, in which the threaded passage is coaxial with said cavity and of a smaller diameter.

15. A mounting assembly according to any of claims 12 to 14, in which the second member comprises a body part locatable in the cavity of the first member and engageable against the ends of the elongate member.

16. A mounting assembly according to claim 15, in which the second member comprises a head part of greater diameter than the body part, and locatable against said upper part of the first member.

17. A mounting assembly according to claim 16, in which the threaded passage extends through the head and body parts of the second member.

18. A mounting assembly according to claim 17, in which a threaded passage extends through the first member.

19. A mounting assembly according to claim 18, in which the threaded passage extending through the second member is of the same diameter as the threaded passage extending through the first member.

20. A mounting assembly according to claim 18 or 19, in which the support member comprises an elongate threaded member which, in use, extends through the threaded passages to hold the first and second members together.

21. A mounting assembly according to any preceding claim, in which the elongate member is resilient such that it has to be strained to locate the ends thereof in the mounting bracket.

22. A mounting assembly according to claim 21, in which, in a relaxed condition, the ends of the resilient elongate member are spaced further apart than when located in the mounting bracket.

23. A mounting assembly, the assembly comprising resilient elongate member, and a mounting bracket for holding the two ends of the resilient elongate member such that the member defines a loop in which articles can be supported, the mounting bracket comprising a first member in which the ends of the elongate member are locatable and a second member extendible into the first member to hold the said ends therein.

24. A mounting assembly according to claim 23, in which the first and/or second member is threaded and engagable with an elongate threaded support member to retain the first and second members together.

25. A mounting assembly according to claim 24, in which the support member permits mounting of the assembly to a fixture.

26. A mounting assembly according to claim 24 or 25, in which the support member comprises a head spaced from the elongate member, which head is movably trapped within a body such that the support member is supported by the body and extends therefrom, but the respective alignment therebetween can be varied.

27. A mounting assembly as claimed in any preceding claim, in which the body includes a keyhole entry through which the head may pass and which leads to a well within the body in which the head is trapped.

28. A mounting assembly as claimed in claim 27, in which the head is trapped by an elongate suspension member displaceable above the well to prevent removal of the head from the well.

29. A mounting assembly as claimed in any preceding claim, in which the head is an hexagonal nut head of a bolt secured in the assembly.

30. A mounting assembly according to any of claims 1-22 and any of claims 23-29.
